(19) United States
(12) Patent Application Publication
(10) Pub. No.: US 2018/0318727 A1
(43) Pub. Date: Nov. 8, 2018

(54) COLUMN FOR HEAT AND/OR MASS EXCHANGE BETWEEN TWO FLUIDS COMPRISING A COLLECTION TRAY AND FLUID SEPARATION MEANS

(71) Applicants: TOTAL SA, Courbevoie (FR); PROSERNAT, Rueil-Malmaison (FR); IFP Energies nouvelles, Rueil-Malmaison Cedex (FR)

(72) Inventors: Gauthier PERDU, Suresnes (FR); Clement SALAIS, Paris (FR); Vincent CARLIER, Lyon (FR); Claire WEISS, Vaucresson (FR); Thomas MAUBERT, Paris (FR); Maxime FOURNIE, Paris (FR); Manel FOURATI, Lyon (FR); Pascal ALIX, Roussillon (FR); Philippe BEARD, Saint Genis-Laval (FR)

(73) Assignees: TOTAL SA, Courbevoie (FR); PROSERNAT, Rueil-Malmaison (FR); IFP Energies nouvelles, Rueil-Malmaison Cedex (FR)

(21) Appl. No.: 15/772,332

(22) PCT Filed: Oct. 30, 2015
(86) PCT No.: PCT/FR2015/052933

§ 371 Date: Apr. 30, 2018

(51) Int. Cl. B01D 3/00; B01D 53/18

(52) U.S. Cl. CPC B01D 3/008; B01J 8/0492; B01D 53/18

(57) ABSTRACT

The present invention relates to a column for exchanging material and, if appropriate, heat between a gas and a liquid. The column comprises at least one collector tray 1 and a liquid distribution system 5, 6 arranged between two packed beds 7, and gas and liquid separation means 8. The present invention proposes arranging gas and liquid separation means 8 between the collector tray 4 and the liquid distribution means 5, 6.

The present invention relates to the field of gas/liquid contacting columns. The fields of application of the invention can be gas treatment, CO₂ capture, dehydration, separation of contaminants present in gas flows by a liquid solution or even the distillation of liquid compounds in mixture.

The industry uses a very large number of gas/liquid contactors (contacting columns). The latter can be used for the separation of products, such as distillation methods, or even the absorption of contaminants, like the amine-based treatment methods, in the gas treatment and/or CO₂ capture sector. When it concerns removing contaminants present in the gas, like CO₂, water, H₂S, by liquid washing methods, vertical contactors are used, which wash the gas by counter-current liquid flow. Thus, the gas contaminants are retained by the liquid. Also understood to be vertical contactors are the regeneration towers in which the contaminant-charged solvents (liquid) are purified through contact with a gas, which favors the extraction of the contaminants present in the contaminant-charged solution.

There is a wide variety of gas/liquid contactor types. Conventionally, the vertical contactors can contain contact internals of random packing and/or structured packing type, and implement several packed beds with intermediate redistribution of the liquid flow, as schematically represented in FIG. 1. For example, for the case of the absorption of acid gases by an aqueous solution of amine(s), it is possible to use a gas/liquid contacting column CO containing packing distributed in a plurality of packed beds 7. The contacting column CO receives the gaseous fluid to be treated at the bottom of the column FA, and the depleted solvent (liquid) at the head of the column SP. The contacting column CO delivers the treated gaseous fluid FT, purified of some of the contaminants, at the head of the column and the enriched solvent SR, charged with some of the contaminants contained in the gaseous fluid to be treated, at the bottom of the column. The transfer of the contaminants from the gaseous fluid to the liquid solvent is done by placing the descending liquid phase and the ascending vapor phase in intimate contact within the contactor, at the packed beds 7. The packed beds 7 are composed of solid elements which have a high contact surface, on which the liquid is distributed uniformly and flows downward, which favors the contact with the ascending vapor phase, and thus makes it possible to efficiently transfer material and/or heat between both fluids.

Two large families of packings are currently available. A first type of packing consists of a multiplicity of singular solid elements, possibly identical and generally of moderate size (ten or so centimeters), randomly arranged within the contactors, hence the name random packing. The second type, called structured packing, is generally formed by steel plates shaped and arranged in a particular manner.

For all the types of packing, in order to benefit from the entire surface developed by the transfer internal, it is advisable for each of the flows streaming in counter-current to flow in the most uniform manner possible over the entire section of the column, and of the contact internals of the column. To this aim, the depleted solvent SP, at the head of the column, is injected uniformly over the section of the head packed bed 7, using a liquid distributor 14. Generally, the elements that make up the packed beds make it possible to form and/or maintain a uniform distribution of the fluids over the entire contact section. However, when a tall contact height is required, it is preferable to use a plurality of packed beds 7 and a plurality of associated liquid redistribution systems. Indeed, during the passage of a liquid within a packing, the latter tends to build up in certain preferential passage zones, generating radial concentration gradients (over the section of the column) for the gas and liquid phases, thus degrading the liquid and gaseous fluid contacting performance and the overall efficiency of the column. It then becomes preferable to dedicate a part of the column to the installation of liquid collecting and redistributing devices. This is done in order to allow for the most uniform possible redistribution of the liquid flow over the surface of the lower packing 7.

“Fractionation Research Inc.” (FRI) recommends limiting the height of a packed bed to a height of eight meters and mixing the liquid phase again before re-introducing it over a lower packing section (FRI reference, Fractionation Tray Design Handbook, vol. 5: Design Practices). This maximum height can vary depending on the case, and depends on numerous parameters which can be: the operating conditions and flow rates, disturbances external to the column such as movement forces on the columns installed in floating conditions on supports such as production barges and vessels, the packing type, the properties of the fluids, the operational conditions, etc. The segmentation of the contact zone into a number of packed beds 7 then entails the implementation of liquid redistribution systems 5, linked to collector trays 1. They are installed between two packed beds, that is for this illustrated example, above the intermediate and lower packed beds 7.

Generally, the behavior of the liquid flow is considered to be most critical for the correct operation of the contactors, but the behavior of the gaseous fluid is also a parameter that is important to the efficiency of the column. Indeed, the gas flow is generally introduced at the bottom of the contactor using a gas distributor (13 according to the example of FIG. 1). Like the liquid distributor applied to the liquid, the gas distributor makes it possible to make the velocity profile of the ascending vapor phase uniform at best over the entire lower section of the packed bed in order to improve the operating performance levels of the contactor. It is also important for the gas to have high and uniform velocities, in order to favor the intimate contact with the liquid and ensure the efficiency of the contaminant transfer.

Also, for the contacting columns of the prior art, entrainments of liquid by kinetic effect of the velocity of the gas, by virtue of the velocity of the gas, are observed. The liquid entrainments by the vapor phase, between the contact zones, have been perceived as disruptive elements to the correct operation of the gas/liquid contactors. The liquid flowing in the upper zone of the liquid redistributor is polluted by these liquid entrainments that are richer in compounds to be eliminated (CO₂ and/or H₂S in the case of an absorption column, residues in the case of distillation), leading to a loss of separation efficiency of the upper zone. The term “backmixing” then applies. The operation of the column becomes all the more sensitive to the backmixing when close to thermodynamic equilibrium and the transfers between phases become low on the transfer stages of the column (distillation, stripper, H₂S absorption, etc.). Moreover, the liquid entrainment is all the more significant when the gas velocities are high. The tendency to liquid frothing, which is a known phenomenon of the amine aqueous solution washing methods, also increases the efficiency losses. Such solutions, exhibiting a tendency to frothing, when they are used with high gas velocities further increase the efficiency losses, through the phenomena of preferential passage and obstruction of the gas in sections of reduced passage. Also, the liquid entrainment by the vapor phase can generate an early congestion of the columns. The phenomenon of entrainment of the droplets by the vapor phase occurs when the entrainment force of the droplets by the ascending gas is greater than the force of gravity which entrains the droplets downward.

Many developments have been made in the gas/liquid contactors in order to limit the phenomenon of liquid entrainment by the vapor. Some developments in particular consist in increasing the separation height “called zone of disengagement”, where the liquid droplets can fall back before reaching the immediately upper transfer zone, and polluting it.

For example, for the tray contactors, a zone between each contactor tray (contact zone) is provided to allow the disengagement of the vapor and of the liquid. To limit this disengagement height (separation of the liquid droplets), the U.S. Pat. No. 5,762,668 proposes assembling a thickness of structured packing under gas/liquid contact trays in order to more efficiently separate the liquid entrained with the vapor from the lower gas/liquid contact tray, and thus reduce the height of disengagement. On the same theme, the U.S. Pat. No. 4,698,138 and U.S. Pat. No. 8,083,901 indicate particular geometries for devices for covering the liquid collector tray risers in order to limit the liquid entrainment with the vapor phase.

In the gas/liquid contactors with packing, it appears that the conditions observed at the output of the liquid redistribution system most particularly increase the phenomenon of entrainment of liquid droplets (the bulk of the liquid distributors reduces the size of the gas passage section generating significant accelerations of the gas velocities and therefore an increase in the force of entrainment of the droplets by the gas). Furthermore, the liquid injection mode, at the liquid distributors, can exacerbate the liquid entrainment by the vapor phase. The patent US 2014/0361449 mentions in particular that, for spray liquid distributors, up to 5% of the liquid flow rate can be entrained with the ascending vapor phase in the shape of mist.

Among the liquid redistribution systems installed between two successive packed beds, two types of systems are used to collect the liquid from the upper packed bed and redistribute it to the lower packed bed.

A first type of system uses a single device making it possible to both collect the liquid from the upper packed bed and redistribute it to the lower packed bed while allowing the passage of the vapor phase, generally using risers. These are generally systems that are simple and economical but which moderately favor the mixing of the liquid phase. In this type of system, three major families are distinguished:
Liquid distributors with gas risers: A liquid seal is established over the entire section of the distributor tray, and supplies the contact (packing) bed via orifices uniformly distributed over the bottom of the tray. The gas is routed via risers (e.g. US 2013/0277868A). FIG. 2 shows a conventional distributor tray 1 with risers, provided with risers 2 for the passage of the gas, the risers being covered by “caps” 3 to avoid the passage of liquid within the gas risers (in a counter-current flow situation), and orifices 4 for the passage of liquid.
Liquid distributors with liquid boxes: A liquid seal is established over a set of boxes provided with supply orifices, and the gas is routed via the remaining space (e.g. U.S. Pat. No. 4,909,967A).
Liquid distributors with liquid risers: These distributors operate according to the same principle as the distributor with gas risers. The difference is that the liquid is distributed via risers that can have orifices situated at several different heights, thus making it possible to have a wider area of flow rate pass than in the case of simple orifices in the bottom of the tray. The gas is, for its part, routed via risers that can have a cylindrical or parallelepipedal shape (e.g. U.S. Pat. No. 5,132,055A, U.S. Pat. No. 4,432,913).

A second type of system uses distinct devices to collect the liquid from the upper packed bed and to redistribute it to the lower packed bed, the liquid being transmitted from one system to the other via liquid transfer legs (conduits); the passage of the vapor phase being generally performed using risers. These are generally robust systems, which favor the mixing of the liquid phase. Within this type of system, it is best to separate the collecting part from the distributing part. The document “Process Engineering Guide: GBHE-PEG-MAS-612 Design and Rating of Packed Distillation Columns” notably illustrates these different systems. The liquid collection devices are generally differentiated by the means making it possible to enable the vapor flow to pass:
collector trays with circular gas risers, provided with caps,
collector trays with rectangular gas risers, provided with caps, and
collector trays with gutter-type gas risers.

The liquid distribution devices are generally distinguished into four families:
trough distributors, rather compact but demanding a perfect horizontality (advised against in critical services and in floating offshore conditions),
tray with perforated risers, or “orifice riser type distributor”, rather compact, but reserved for columns of small diameter (less than 1 m), demanding a perfect horizontality: the defects of uniformity of distribution are generally significant (advised against in critical services and in floating offshore conditions),
tubular distributor with orifices, or “perforated piping distributor”, not very compact, exhibiting a greater head loss than the preceding distributors and requiring a generally more significant static liquid height, but generally delivering a good distribution of the liquid, and
sprayers or nozzles, or “spray distributors”, not very compact, requiring, like the preceding distributor, a significant static height (a pump can also be used to ensure the distribution force). The distribution uniformity performance is more moderate on the liquid (because of the creation of overlapping zones of the liquid cones). The impact of the droplets on the packing is significant for dispersing the liquid force and the system is very greatly subject to the liquid entrainment by the creation of droplet mist.

FIG. 3 shows an example of the latter type of system which dissociates the collection of the liquid from the distribution thereof. The collector tray 1 comprises risers 2 for the passage of the gas. The system for the distribution of the liquid comprises a vertical conduit 5 and a plurality of sprinklers 6 (horizontal pipes provided) with orifices or nozzles).

For floating offshore conditions, it is generally this type of system illustrated in FIG. 3, ensuring the collection and the redistribution of the liquid between two packed beds, which is preferred. Also, the liquid collector tray is linked to the distribution system by one or more relatively long vertical conduits in order for the distributor system to create the adequate static height regardless of the swell conditions encountered. Indeed, the vertical conduit is engineered such that the variation of the liquid height due to a defect of horizontal alignment is much less than the height of the liquid conduit supplying the distribution system (US008118284B2, US 2004/0020238 A1). In this case, the liquid distribution system can be formed by one or more sprinklers, and the gas is routed by risers situated at the level of the collector tray.

The conditions encountered on floating offshore most particularly increase the liquid entrainments. On the one hand, because of a reduced maximum height of the packed beds (degradation of the liquid distribution with the effect of the swell), more liquid redistribution systems have to be considered, thus increasing the number of inter-bed zones subject to the liquid entrainments. Also, for all the designs that can be contemplated for the redistribution system and in particular for the redistribution system illustrated in FIG. 3, the force which allows the redistribution of the liquid is only created by the static height of liquid in the distributor. The powerful static heights of liquid, notably in the case of the redistributors in floating offshore conditions, lead to a phenomenon of bursting of the liquid jets flowing to the surface of the packing, thus generating fine droplets which can be entrained by the ascending gas phase. Also, in floating offshore conditions, it is possible for, locally, very strong gas velocities to be obtained because of possible significant liquid and vapor flow disparities within separation columns. These significant disparities can be created by the movements of the swell, and which could increase the liquid entrainment phenomena. The quality of the liquid distribution at the head of the bed can then be degraded. Thus, such splashing, combined with the upward flow of the gas phase, creates not inconsiderable liquid droplet entrainments toward the upper zone which are added to the liquid entrainments generated by the gas flow itself upon contact with the liquid phase in the gas/liquid contactors. FIG. 4 illustrates this phenomenon. In FIG. 4, a collector tray 1 is placed between two packed beds 7. The collector tray is linked to a distribution system which comprises a vertical conduit 5 and a system of sprinklers 6 (horizontal pipes). In this figure, the ascending trajectory of the gas is referred to by the arrows GA, the splashing at the surface of the packing 7 is referred to by EC and the entrainment of the liquid droplets GO (dispersed phase) by the gas is referred to by the arrows LI.

To limit the liquid entrainment by the gas phase, hitherto the constructors of gas/liquid contactors using (random and/or structured) packings prioritize making the liquid redistribution conditions less favorable. To this aim, the patents US 2014/0361449, U.S. Pat. No. 6,722,639, U.S. Pat. No. 6,575,437 and U.S. Pat. No. 5,139,544 in particular generally describe the use of deflectors to avoid a direct contact between the liquid flow leaving the redistributor and the ascending vapor flow, and prioritize limiting the direct contact between the liquid and the vapor phase only at the lower packed bed.

The present invention relates to a column for exchanging material and, if appropriate, heat, between a gas and a liquid. The column comprises at least one collector tray and a liquid distribution system arranged between two packed beds, and gas and liquid separation means. Thus, the liquid entrainment by the gas is limited in the inter-bed zone. The present invention proposes arranging gas and liquid separation means between the collector tray and the liquid distribution means, such that the gas which passes through the collector tray is “dry”, that is to say with few droplets entrained by the gas. The objective of the invention is therefore to improve the performance levels of the columns equipped with several beds of internals with intermediate collection and redistribution devices.

### The Device According to the Invention

The invention relates to a column for exchanging material and/or heat between a gas and a liquid comprising at least two packed beds, a collector tray arranged between two packed beds, and distribution means for distributing said liquid collected by said collector tray from an upper packed bed to a lower packed bed, said distribution means being situated below said distributor tray. The column further comprises means for separating said liquid, said separation means being arranged between said collector tray and said distribution means.

According to the invention, said means for separating said liquid entrained by the gas comprise at least one impact element, on which said liquid impacts then descends in said column by gravity.

According to an embodiment of the invention, said impact element is an inclined plate.

Advantageously, said plate is substantially in the shape of an inverted L.

According to a variant, said impact element comprises at least one chicane.

Preferably, said chicane is formed by at least one chevron.

As a variant, said impact element is formed by a lattice or mat of fibers.

According to a variant, said impact element is formed by a packing.

According to an aspect of the invention, said impact element is substantially in the shape of a ram's horn.

According to a characteristic, said means for separating said liquid entrained by the gas further comprise at least one cannula for draining said liquid.

Advantageously, said means for separating said gas and said liquid are arranged in proximity to said distribution means.

According to an embodiment, said distribution means comprise at least one vertical supply conduit linked to said collector tray and at least one substantially horizontal pipe linked to said supply conduit, said substantially horizontal pipe comprising at least one orifice and/or one nozzle for the distribution of said liquid. Preferentially, said means for separating said liquid entrained by the gas are arranged around said vertical supply conduit.

According to a design, said means for separating said liquid entrained by the gas occupy substantially from 15 to 98% of the cross section of the column available for the passage of the vapor.

Furthermore, said collector tray can comprise at least one riser for the passage of said gas.

Furthermore, the invention relates to the use of a column according to one of the preceding features for a gas treatment, acid gas capture, distillation, dehydration or air separation method.

### BRIEF DESCRIPTION OF THE FIGURES

Other features and advantages of the device according to the invention will become apparent on reading the following description of nonlimiting exemplary embodiments, with reference to the figures attached and described hereinbelow.

FIG. 1, already described, illustrates a diagram of a gas/liquid contactor containing packing, operating in counter-current, and implementing several packed beds with intermediate redistribution of the liquid flow, according to the prior art.

FIG. 2, already described, illustrates a collector tray with risers according to the prior art.

FIG. 3, already described, illustrates a collector tray equipped with a distribution system according to the prior art.

FIG. 4, already described, illustrates the phenomenon of liquid entrainment by the vapor for a collector tray equipped with a distribution system according to the prior art.

FIG. 5 illustrates a portion of a column according to a first embodiment of the invention.

FIG. 6 illustrates a portion of a column according to a second embodiment of the invention.

FIG. 7 illustrates a portion of a column according to a third embodiment of the invention.

FIG. 8 illustrates a separation means according to an embodiment of the invention.

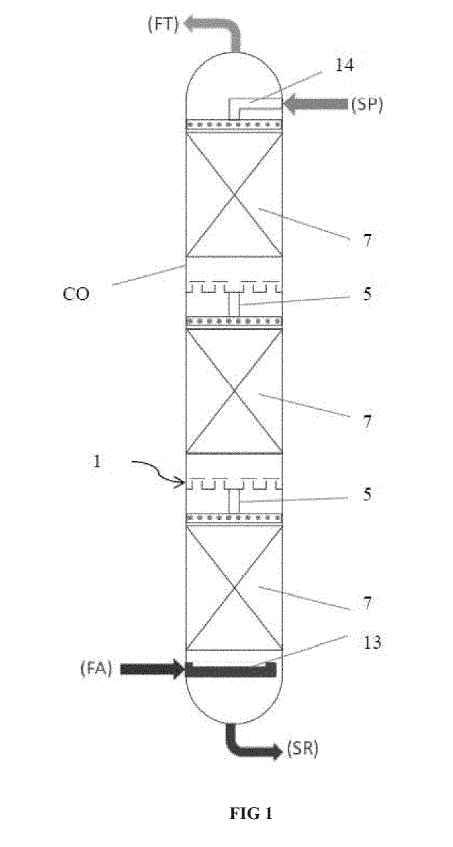

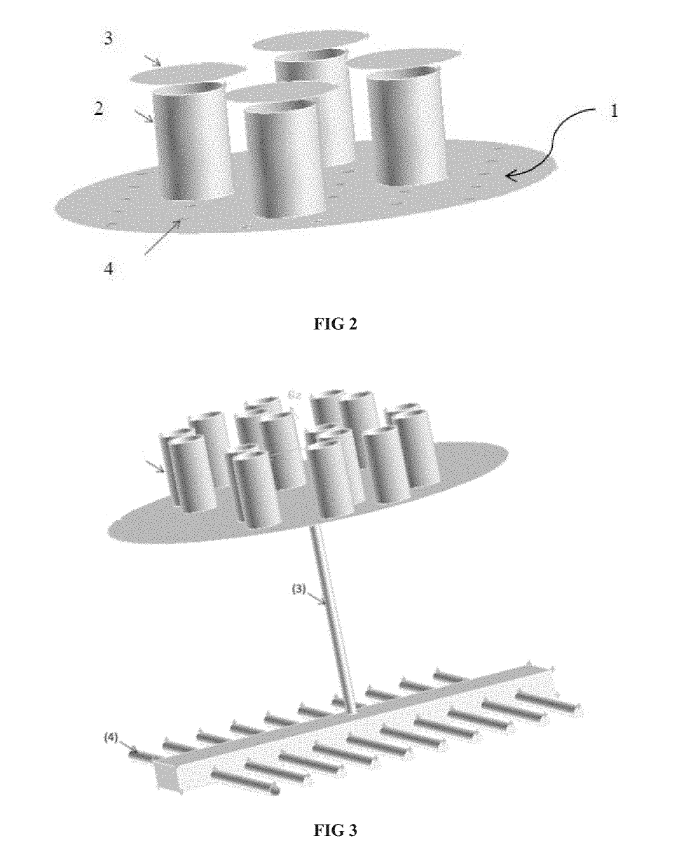

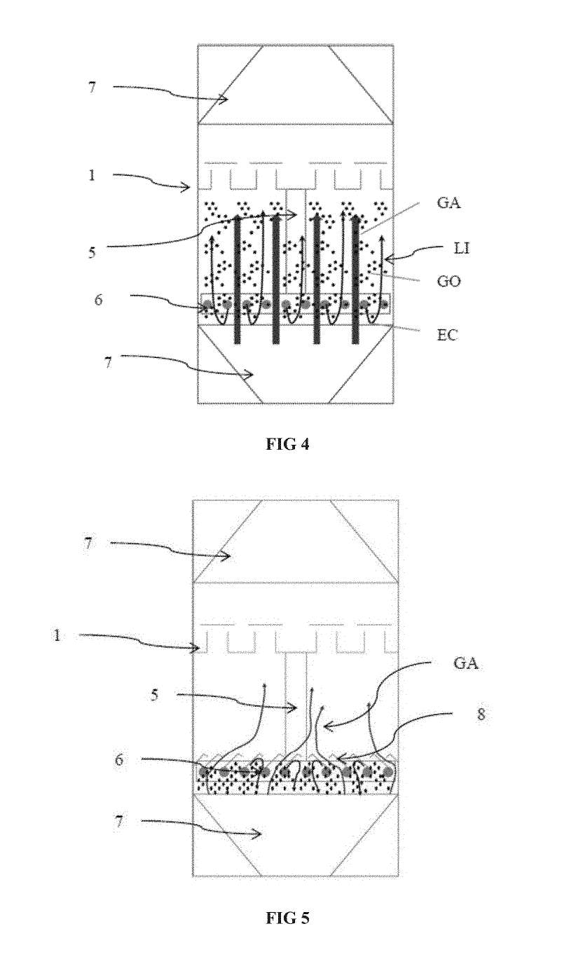

### DETAILED DESCRIPTION OF THE INVENTION

The present invention relates to a column for exchanging material and possibly heat between a gas and a liquid. According to the invention, the exchange column comprises at least two packed beds. The term packed bed is used to denote a packing section which is distributed over a certain height of the column. The packing can be random packing or structured packing. The packing corresponds to a contactor, and makes it possible to bring the liquid and the gas into contact, in order to enable the exchanges of heat and/or of material between the fluids.

According to the invention, the exchange column comprises at least one liquid redistribution system comprising a collector tray and a liquid distributor. Each liquid redistribution system is arranged between two packed beds, in a zone called inter-bed zone. The collector tray collects the liquid on its upper surface, and allows the passage of the gas through the tray. The passage of the gas through the tray can be notably performed by means of risers, equipped or not equipped with caps. Indeed, upon the passage of a liquid through a packing, the latter tends to build up in certain preferential passage zones, generating radial concentration gradients (over the section of the column) for the gas and liquid phases, thus degrading the efficiency of contact of the liquid and gaseous fluids and the overall efficiency of the column. When a tall contact height is required, it becomes preferable to use a plurality of packed beds and a plurality of liquid collection and redistribution devices. In this case, it is advantageous to redistribute as uniformly as possible the flow of liquid over the surface of the lower packing. It becomes generally preferable to use liquid collectors/redistributors between two packing sections, beyond a packing height of eight meters (height recommended by the FRI). This recommended maximum height can be modified (generally reduced) depending on the operating conditions (floating offshore, packing type, fluid properties, operational conditions, etc.).

According to the invention, the exchange column comprises liquid distribution means. The liquid distribution means are situated below the collector tray in the inter-bed zone, and are linked to the collector tray for the passage of the liquid. The liquid distribution means make it possible to distribute the liquid from the collector tray over a lower packed bed. Thus, the liquid flows by gravity from an upper packed bed, through the collector tray and distribution means to be distributed over a lower packed bed. The distribution means can be of any known type, notably that illustrated in FIG. 3 (tubular distributor with orifice). Alternatively, the distribution means can be spray (with nozzles) or trough distribution means. The liquid distribution means allow for a good liquid distribution over the lower packed bed, including in floating offshore conditions (at sea), for which the column can be inclined relative to the vertical.

The column according to the invention further comprises gas and liquid separation means. The gas and liquid separation means are arranged between the collector tray and the liquid distribution means. The gas and liquid separation means make it possible to separate the liquid droplets from the gas which entrains them upward. Thus, the liquid droplet entrainment by the gas is reduced, the backmixing phenomenon is limited and the efficiency of the column is maintained. The arrangement of the separation means between the collector tray and the distribution means makes it possible for the gas passing through the distributor tray (entering and leaving) to be “dry”, that is to say without liquid droplets entrained by the gas. “Dry” gas should be understood to be a gas entraining less than 10 ml of liquid droplets per Sm³ of gas, preferably entraining less than 1 ml and more preferably entraining less than 0.1 ml.

Preferably, the gas and liquid separation means can be situated in proximity to the distribution means, that is to say just above the distribution means, and away from the collector tray: the gas and liquid separation means are then closer to the distribution means than the collector tray. Thus, the droplet entrainment zone is limited to a low height, and the rest of the inter-bed zone can continue the action of de-entrainment by the force of gravity. The separated liquid is sent back into direct proximity to the lower packed bed, and the re-entrainment phenomenon is lessened. Thus, the droplets are advantageously reinjected into the lower packed bed by gravity.

According to an embodiment of the invention (that can be combined with the different variants described hereinbelow), the distribution means comprise at least one vertical supply conduit linked to the collector tray, and at least one, preferably a plurality of, substantially horizontal pipe(s) linked to the supply conduit. Each horizontal pipe is equipped with at least one orifice and/or one nozzle for the distribution of the liquid.

Advantageously, for this embodiment, the gas and liquid separation means can be arranged around the vertical conduit. Furthermore, preferably, the gas and liquid separation means are arranged in proximity to the horizontal pipes of the distribution means. Preferentially, these separation means are situated in the lower half of the fluid distribution zone, and more preferentially in the lower quarter of the distribution zone.

According to an embodiment of the invention (that can be combined with any one of the embodiments described), the gas and liquid separation means occupy between 15 and 98%, and preferably substantially more than 75%, of the cross section of the column available for the passage of the vapor phase. Thus, the separation of the droplets and of the gas is performed over virtually the entire section of the column, which allows for an efficient separation, which makes it possible to minimize the entrainment of the droplets to the collector tray, and a fortiori to the upper packed bed.

According to an embodiment of the invention (that can be combined with the embodiments described above), the gas and liquid separation means comprise at least one (preferably a plurality of) impact element(s), on which the liquid droplets impact and build up then descend in the column by gravity. The principle used for this embodiment is the separation by impact of the liquid droplets on a surface (for example metal), a lattice or any other obstacle placed over the passage of the gas flow. This is then called separation by “impaction”. The impaction principle consists in accumulating the liquid droplets on the surface, then in grouping them together by coalescence, until the force of gravity becomes greater than the entrainment force of the gas. The obstacle (impact element) can have different profiles. The gas flow is directed toward the obstacle, on which the liquid droplets impact to form large drops, and, subsequently, form a liquid film by coalescence. The force of gravity can then compensate the combined effect of the gas entrainment and of the surface tension. The liquid film is then drained from the obstacle (the impact element) to the lower packed bed.

Advantageously, the impact elements can be metal, or produced in any type of material resistant to the operating conditions of the column. Furthermore, the impact elements can be fixed directly to the column or to the liquid distribution means.

This embodiment can be combined with distribution means comprising a vertical conduit and horizontal pipes, for example according to the design of FIG. 3. Alternatively (and for all the variant embodiments described hereinbelow), this embodiment can be adapted to distribution means of any type, notably trough or spray means.

According to a first variant of this embodiment, the impact element can be formed by an inclined plate. The inclined plate can be a corrugated plate, so as to favor the coalescence of liquid drops in order to form a liquid film in the corrugations. Furthermore the plate can, in cross section, be substantially in the shape of an inverted L, that is to say with the head downward (that is to say substantially the shape of a gamma F). This shape favors the impaction of the liquid droplets, and therefore the separation of the gas and of the liquid.

FIG. 5 illustrates, in a nonlimiting manner, an exemplary embodiment of this first variant. A collector tray 1 is placed in the inter-bed zone between two packed beds 7. As represented, the collector tray 1 comprises a number of risers equipped with caps for the passage of the gas. The distribution means comprise a vertical conduit 5 and a set of horizontal pipes 6 equipped with orifices and/or nozzles. FIG. 5 illustrates only two packed beds and one collector tray, but the column can comprise several packed beds, one such collector tray (with the distribution means and the separation means) being inserted in each inter-bed zone. The gas and liquid separation means comprise a plurality of inclined plates 8 substantially in the shape of an inverted L: the lower part of the L becomes its upper part, and its height is inclined relative to a vertical axis. The inclined plates 8 are arranged just above the horizontal pipes 6 of the distribution means. As represented, the inclined plates 8 are oriented toward the center of the column, so as to allow a uniform distribution of the gas flow. By virtue of the shape and of the arrangement of the inclined plates 8, only the gas GA flows between the inclined plates 8, which makes it possible to limit the entrainment of the droplets, thus favoring the efficiency of the column.

According to a second variant of this embodiment, the impact element can form chicanes which modify the trajectory and the kinematics of the gas in order to preferentially spray the droplets onto the walls. According to a design of this variant, the chicanes can be produced by impact elements substantially in the shape of a chevron (or inverted V), or any other shape that modifies the trajectory of the gas by sets of chicanes. The gas and liquid separation means can comprise several rows of chevrons, preferably between 1 and 5 rows. The chevrons of one row can be offset relative to the adjacent rows, so as to increase the number of chicanes, which favors the separation of the gas and of the liquid.

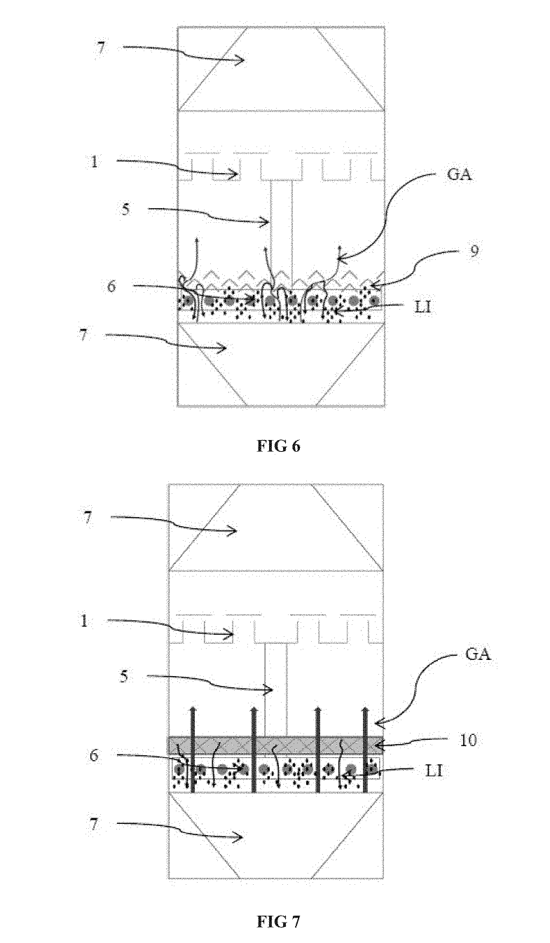

FIG. 6 illustrates, in a nonlimiting manner, an exemplary embodiment of this second variant. A collector tray 1 is placed in the inter-bed zone between two packed beds 7. As represented, the collector tray 1 comprises a number of risers equipped with caps for the passage of the gas. The distribution means comprise a vertical conduit 5 and a set of horizontal pipes 6 equipped with orifices and/or nozzles. FIG. 6 illustrates only two packed beds and one collector tray, but the column can comprise several packed beds, one such collector tray (with the distribution means and the separation means) being inserted in each inter-bed zone. The gas and liquid separation means comprise, by way of example and in a nonlimiting manner, three rows of chevrons 9. For this configuration, the arrangement of the chevrons 9 of the central row is offset relative to the arrangement of the chevrons 9 of the first and third rows. The rows of chevrons 9 are arranged just above the horizontal pipes 6 of the distribution means. By virtue of the shape (inverted V) and of the arrangement of the chevrons 9, only the gas GA passes through this arrangement of chevrons 9, whereas the liquid LI is redirected toward the lower packed bed 7, which makes it possible to limit the entrainment of the liquid droplets, thus favoring the efficiency of the column.

According to a third variant of this embodiment, the impact element can be formed by a lattice, the lattice being able to be compacted in a volume also called mat. The lattice and/or the mat can be formed by a mesh, notably of metal. The liquid droplets then impact on the lattice, to be separated from the gas.

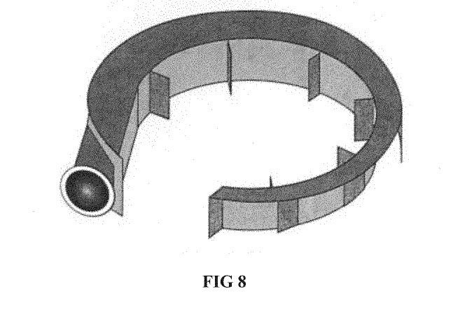

FIG. 7 illustrates, in a nonlimiting manner, an exemplary embodiment of this third variant. A collector tray 1 is placed in the inter-bed zone between two packed beds 7. As represented, the collector tray 1 comprises a number of risers equipped with caps for the passage of the gas. The distribution means comprise a vertical conduit 5 and a set of horizontal pipes 6 equipped with orifices and/or nozzles. FIG. 7 illustrates only two packed beds and one collector tray, but the column can comprise several packed beds, one such collector tray (with the distribution means and the separation means) being inserted in each inter-bed zone. The gas and liquid separation means comprise a mat of fibers 10. The lattice (or mat of fibers) 10 is placed just above the horizontal pipes 6 of the distribution means. By virtue of the shape and of the arrangement of the lattice 10, only the gas GA passes through this lattice 10, whereas the liquid LI is redirected toward the lower packed bed 7, which makes it possible to limit the entrainment of the liquid droplets, thus favoring the efficiency of the column.

According to a fourth variant of this embodiment, the impact element can be formed by a volume of packing. The packing can be a random packing or a structured packing. Preferably, the packing type used as gas and liquid separation means can be identical to the type of packing used in the packed beds of the column. The liquid droplets then impact on the packing to be separated from the gas.

An exemplary design of this fourth variant can consist in taking the configuration of FIG. 7 and replacing the lattice 10 with a packing.

According to a fifth variant of this embodiment, the impact element can be substantially in the shape of a ram's horn (called “vapor horn”). This type of impact element makes it possible to both limit the liquid entrainment and to reorganize the vapor flow.

FIG. 8 illustrates an exemplary, nonlimiting embodiment of an impact element 11 substantially in the shape of a ram's horn.

Advantageously, and for all the variant embodiments described previously, the gas and liquid separation means can comprise cannulas to facilitate the draining of the liquid droplets to the lower packed bed, without contact with the gas flow.

Different types of separation means (for example several impact elements) can be combined to optimize the separation of the gas and of the liquid.

The column according to the invention is advantageously an amine-based washing column but it is suitable for all types of solvents used in absorption.

The column according to the invention is suitable for the counter-current flows.

The column according to the invention can be used in gas treatment, CO₂ capture, liquid product distillation, dehydration, air separation or heat exchange methods. The column according to the invention can be used for floating offshore or on-land applications.

Furthermore, the invention can more particularly relate to floating barges or offshore platforms, for example of FPSO (floating production, storage and offloading) type, or of the FLNG (floating liquefied natural gas) type. On the floating barges, distillation columns and/or dehydration columns using this device can also be installed.

1. A column for exchanging material and/or heat between a gas and a liquid comprising at least two packed beds (7), a collector tray (1) arranged between two packed beds (7), and distribution means for distributing said liquid collected by said collector tray from an upper packed bed (7) to a lower packed bed (7), said distribution means being situated below said collector tray (1), characterized in that the column further comprises means (8, 9, 10, 11) for separating said liquid entrained by the gas, said separation means (8, 9, 10, 11) being arranged between said collector tray and said distribution means.

2. The column as claimed in claim 1, in which said means (8, 9, 10, 11) for separating said liquid entrained by the gas comprise at least one impact element, on which said liquid impacts then descends in said column by gravity.

3. The column as claimed in claim 2, in which said impact element is an inclined plate (8).

4. The column as claimed in claim 3, in which said plate (8) is substantially in the shape of an inverted L.

5. The column as claimed in claim 2, in which said impact element comprises at least one chicane.

6. The column as claimed in claim 5, in which said chicane is formed by at least one chevron (9).

7. The column as claimed in claim 2, in which said impact element is formed by a lattice or mat of fibers (10).

8. The column as claimed in claim 2, in which said impact element is formed by a packing.

9. The column as claimed in claimed 2, in which said impact element is substantially in the shape of a ram's horn (11).

10. The column as claimed in claim 1, in which said means (8, 9, 10, 11) for separating said liquid entrained by the gas further comprise at least one cannula for draining said liquid.

11. The column as claimed in claim 1, in which said means (8, 9, 10, 11) for separating said gas and said liquid are arranged in proximity to said distribution means.

12. The column as claimed in claim 1, in which said distribution means comprise at least one vertical supply conduit (5) linked to said collector tray and at least one substantially horizontal pipe (6) linked to said supply conduit, said substantially horizontal pipe (6) comprising at least one orifice and/or one nozzle for the distribution of said liquid.

13. The column as claimed in claim 12, in which said means (8, 9, 10, 11) for separating said liquid entrained by the gas are arranged around said vertical supply conduit (5).

14. The column as claimed in claim 1, in which said means (8, 9, 10, 11) for separating said liquid entrained by the gas occupy substantially from 75 to 98% of the cross section of the column available for the passage of the vapor.

15. The column as claimed in claim 1, in which said collector tray (1) comprises at least one riser (2) for the passage of said gas.

16. A method for gas treatment, acid gas capture, distillation, dehydration or air separation method, comprising processing a gas and a liquid to exchange a material and/or heat between the gas and liquid in a column according to claim 1.
